(19) United States
(12) Patent Application Publication
(10) Pub. No.: US 2007/0044132 A1
(43) Pub. Date: Feb. 22, 2007

(54) Data processing device, data processing system

(75) Inventors: Yuichi Kubo, Odawara (JP); Daisuke Yoshida, Yokohama (JP); Keisuke Inata, Ibina (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 11/502,617

(22) Filed: Aug. 9, 2006

(30) Foreign Application Priority Data
Mar. 1, 2005 (JP) 2005-056296

(51) Int. Cl. H04N 7/16; H04N 7/173

(52) U.S. Cl. 725/116; 725/146; 725/114; 725/144

(57) ABSTRACT

A data processing device capable of indicating data being recorded or already recorded, at a location different from a user home without storing the data in a file format. When a terminal device issues a viewing request for a recorded program to an HDD in the user home, the program stored at a high bit rate is transmitted. Therefore, even if the terminal is a mobile, the program can be viewed on a display. Further, even during recording operation, an already recorded portion is transmitted so that the program can be viewed. Even during concurrent reproduction in which some one views the program during recording while the program is reproduced, the program can be transmitted for a mobile phone so that the program can be viewed at the mobile phone.

### BACKGROUND OF THE INVENTION

1. Field of the Invention

The present invention relates to a data processing device having a function of storing data such as video contents and allowing an external terminal device to read data, and to a data processing system having the data processing device and a terminal device.

2. Description of the Related Art

A video recorder for viewing video contents broadcast by television broadcasting while the video contents are recorded or after the video contents are recorded is usually a recording/reproducing device equipped also with a reproduction function. Therefore, it is generally possible to reproduce and view video contents recorded in a recording/reproducing device via wired connection or wireless connection, or to reproduce and view video contents at the same time while the video contents are recorded.

Conventionally, a program recorded by a device having a video recording function such as a server, a personal computer and a hard disk drive is stored in a storage device such as a hard disk drive (hereinafter called an HDD), and the stored program can be viewed directly on a television receiver or on a personal computer, a mobile terminal or the like via a communication means such as a local area network (LAN), a wide area network (WAN), a public line and a private line. With this conventional configuration, a program once recorded can be viewed on a television receiver connected to a video recording device or can be viewed by connecting a video recording device to various terminals and downloading the program in a file format.

A contents distribution system allowing a user to view the contents stored in a home server in the house by using a mobile terminal at a destination site has been proposed, for example, in JP-A-2003-37802 (paragraphs [0026] to [0034], [0069] to [0073], FIGS. 1 and 10). According to this proposal, broadcast contents are received at a home server of a user and stored in a storage device. When the user desires to distribute the stored contents to a mobile terminal, authentication data is transmitted from the mobile terminal to the home server. As the home server recognizes that the mobile terminal was registered by the user, the home server distributes the contents designated by the user among the contents stored in the storage device, to the mobile terminal. A mobile information terminal wireless LAN service system has been proposed, for example, in JP-A-2004-80083 (paragraphs [0015] to [0023], FIG. 1). This mobile information terminal wireless LAN service system comprises: means for automatically transferring recorded data of a television program preset by a user to a wireless LAN agent server via a communication line; and means for wirelessly transmitting the data from the wireless LAN agent server to a mobile information terminal when it is detected, with an antenna installed at a particular point for supplying information, that a user having the mobile information terminal passes in a particular area, wherein the user owning the mobile information terminal can view the program recorded by the user by using a wireless LAN even at a position where there is no video recording device. Namely, a TV tuner and a disk recorder are built in or externally connected to a personal computer, and a television program which a user reserved and recorded in the personal computer in the home is automatically transmitted to the wireless LAN agent server to be stored therein and managed thereby. When the user at a destination site desires to view the television program reserved and recorded in the home, the user can enjoy the program acquired in the mobile information terminal of the user from the server via the wireless LAN, on the screen of the mobile information terminal. This system also realizes the following operation. If a program reservation is transmitted to the server by using an e-mail, the personal computer in the home connected to the Internet starts automatic recording at a reservation time.

A broadcasting viewing method, a broadcasting server, a mobile terminal, and a multi-point speech/broadcasting control viewing device have been proposed which can allow a user to view a television program freely at a destination site on the mobile terminal even if a specific television broadcasting facility is not provided in the home, as disclosed, for example, in JP-A-2002-185943 (paragraphs [0025] to [0037], FIG. 1) (Patent Document 3). Namely, the broadcasting server receives television broadcasting waves and separates the waves into broadcasting data such as an EPG and program related information, and broadcasting video/audio data. The broadcasting data is transmitted to a request source mobile terminal via a data transmission means, whereas the broadcasting video/audio data is transmitted via a video/audio distribution means. In order to receive the broadcasting data, the mobile terminal issues a request to the television broadcasting server, receives the broadcasting data converted into a proper format, and displays the broadcasting data on a screen of a display device. A user selects an interested program, receives video/audio data of the program, and displays and reproduces it on the display device and from an audio output device.

Further, a contents providing system, a server device and a terminal device have been proposed which can allow a user to perform a recording reservation of a television program or view the recorded television program at a desired location by using a desired terminal device, as disclosed, for example, in JP-A-2003-339041 (paragraphs [0009] to [0011], FIGS. 1 and 2). Namely, the server device distributes a program list of television programs to mobile phones, each user refers to the distributed program list of television programs, and reserves recording of a desired television program via the Internet. As recording a television program is reserved, the server device records the television program reserved for recording. As a view request for the television program is received from the mobile phone, the server device converts the data format of the recorded television program into a data format suitable for a display unit of the portable phone, and transmits the television program with the converted data format to the portable phone. With this configuration, a user can perform easily recording reservation and viewing a television program at any location where the Internet connection is available.

As described above, the systems and devices proposed conventionally for realizing television program recording reservation and recorded television program viewing at a desired location other than a user's home perform program information reception, program recording reservation, and program recording/transmitting via a communication means such as a LAN and a computer communication network and with involvement of a management server. It is difficult for an individual person to manage the management server from the viewpoint of maintenance of a proper environment such as air conditioning in the site where the management server is installed and from the viewpoint of security countermeasures. Generally, an individual person utilizes a server supplied from a provider or the like which is an Internet connection dealer. This professional server imposes a high cost and an individual person cannot use it economically nowadays. In order to view a recorded program at a destination site, it is required that the program is already recorded and stored in a file format. To this end, special circuits and the like for converting the file format are required to be built in

However, in the environment that security is retained by personal authentication, device authentication and the like for various terminal devices including a mobile phone, a PDA, a mobile personal computer and the like other than a television receiver connected to a recording (video recording)/reproducing device, the configuration is still not provided by which the record contents during recording or reproducing by the recording/reproducing devices can be viewed by such various terminal devices from the same recording/reproducing devices. Namely, the configuration is still not provided by which a program already recorded or during recording by recording/reproducing devices can be viewed by various terminal devices other than a television receiver or the like, while the program is viewed by the television receiver or the program is in concurrent reproducing during recording, and data including moving images cannot be viewed by accessing from the terminal or the like.

### SUMMARY OF THE INVENTION

There exists therefore an issue to be solved that a terminal device such as a mobile phone other than a television receiver connected to a recording/reproducing device can view in a security ensured environment a program already recorded or during recording even if the program recorded in the recording/reproducing device is during recording or reproducing, such as during viewing (including concurrent reproducing) the program by the television receiver.

It is an object of the present invention to provide a data processing device and a data processing system including the data processing device and a terminal device, in which various terminal devices are allowed in a security ensured environment to read or view data such as video contents in a communicable environment without any restriction of time and location, even while a program during recording by a recording/reproducing device such as an HDD recorder is viewed on a monitor of a television receiver or the like connected to the recording/reproducing device.

In order to solve the above-described issue and achieve the above-described object, a data processing device of this invention comprises: storing and reproducing units built in or externally connected for storing and reproducing data; a transmission unit for transmitting the data stored in the storing unit to a display device; a communication unit for transferring various information to and from a terminal device; a device authentication unit for authenticating the terminal device in accordance with device identification information of the terminal device sent from the terminal device connected via the communication unit; a conversion unit for transcoding the data reproduced by the storing and reproducing units into a format corresponding to the terminal device authenticated by the device authentication unit; and a control unit connected to each of the units for controlling each of the units to make the transmission unit transmit the data converted by the conversion unit to the terminal device.

According to the data processing device, data reproduced by the storing and reproducing units built in or externally connected for storing and reproducing data is transmitted from the transmission unit to the display device and can be displayed on the display device. The device authentication unit authenticates the terminal device in accordance with the device identification information of the terminal device sent from the terminal device via the communication unit. The conversion unit transcodes the data reproduced by the storing and reproducing units into a format suitable for the terminal device, i.e., a format corresponding to the terminal device, to send the converted data to the terminal device via the communication unit, without storing the data in a file of the terminal device authenticated by the device authentication device. Therefore, even if the storing and reproducing devices are during recording or reproducing, the data can be viewed or used easily at the terminal device. The communication unit of the data processing device can communicate by using a communication means such as a LAN, a wireless LAN, a private line, a public line and an ultra wide band (UWB). The control unit controls each of these units in accordance with the device identification information and performs a series of controls of transcoding the data in the storing unit into a format suitable for the authenticated terminal device and transmits the transcoded data.

In the data processing device, the device authentication unit may authenticate the terminal device by comparing already registered device identification information specific to the terminal device with the device identification information of the terminal device sent from the terminal device. The device identification information may be an address specific to the device such as a device ID. The device identification information is registered beforehand in the device authentication unit so that the device authentication unit can judge whether the terminal device connected to the data processing device is an already registered terminal device. When the terminal device issues a transmission request for the data stored in the data processing device or other requests, device authentication is performed in accordance with the specific device identification information, and when data is transcoded into a format suitable for the terminal device, it is possible to whether the data can be transmitted or not by confirming the registration contents such as a device ID of the terminal device.

In the data processing device, the device authentication unit may have a user identification function or identifying a user using the terminal device. For example, the user identification function judges whether the password sent from the terminal device is coincident with the password already registered and known only by the true user. Since the data processing device has the user identification function, it is possible to judge whether a user using the terminal device is a true user. As this function is applied to the toll system ensuring security, it is possible to protect a copyright, an individual privacy and the like.

In the data processing device, the format of a conversion destination to be converted by the conversion unit in accordance with the device identification information may include various formats including an original image data format, a stream data format, a packet data format, and a compression format. Namely the conversion unit converts the data stored in the storing unit of the data processing device into the transcoded data of various compression schemes including the original image data format, stream data format, and packet data format, respectively of images, moving image contents and computer graphics (CG).

In the data processing device, by an operation of the authenticated terminal device, the functions of the data processing device can be controlled, the functions including special reproduction, fast forward, fast backward, temporary stop, stop, recording, slow reproduction and the like.

In the data processing device, if the data is contents added with copy control information, it is possible to inhibit other devices to copy the data by using the a copy control function equipped to the data processing device. Further, by using the publicization control function equipped to the data processing device, it is possible to set whether the data is publicized or not publicized and to automatically judge from the settings of publicization and non-publicization whether data can be transmitted or not.

The data processing device may be provided a function of, when the data to be used by the terminal device is transcoded into a stream format as one of the formats so as to match the terminal device, directly recording the device identification information of the terminal device to the data of the stream format in order for the terminal device to confirm transmission from the data processing device. Since there exists the function of directly recording the device identification information as the specific information of the terminal device as a connected device, to the stream, when the data processing device transcodes the data into a format suitable for the terminal device, the terminal device can confirm its specific information recorded in the stream when the data from the data processing device is viewed at the terminal device so that the terminal device can indirectly confirm the source location of the data. The device identification information as the specific information may be a telephone number if the terminal device is a mobile phone.

In the data processing device, the data may be audio/video contents such as video signals and audio signals.

If the data is the audio/video contents, the data processing device may further comprises a reception unit for receiving the video signals, wherein the storing and reproducing units may the video signals received by the reception unit. The reception unit may be a reception unit such as a tuner for receiving broadcasting waves, and receives information such as a program. The broadcasting waves may be broadcasting waves receivable at respective bit rates, such as broadcasting waves of BS digital, 110° CS, ground wave digital, analog ground waves, BS analog broadcasting and the like. In this case, the storing and reproducing units may be a video a video recording/reproducing device such as a hard disk for recording received video signals. The data processing device may be a video recording device such as an HDD recorder, a server, a personal computer (PC) or the like, which transmits original image data itself of the recorded program, transmits data such as video signals in a stream format or a format suitable for the terminal device such as a mobile terminal by using various compression schemes or down-converting.

The terminal device may be a mobile terminal such as a mobile phone, a PDA and a mobile personal computer. By using the mobile terminal, data can be transmitted by re-encoding the data in a format suitable for each of mobile information devices. Data stored in the data processing device can be viewed even at a place different from a user home by displaying the data on a screen.

The present invention may be applied also to a data processing system having an environment in which the data now being stored or already stored in the data processing device is used. Namely, the data processing system has an environment wherein the terminal device is connected to the data processing device via a communication means, the terminal device issues a transmission request for the data to the data processing device, the data processing device transmits the data in response to the transmission request by the terminal device, and the terminal device acquires the data transmitted by the data processing device to use the data now being stored or the data already stored in the data processing device.

A user installs the data processing device in a user home, and the terminal device is connected to the data processing device via a communication means such as the Internet, like a sense of accessing a Web server from a mobile phone. In this case, an ID of the terminal device is registered beforehand in the data processing device to allow connection only by authentication of the device ID without a password. As the user selects as data a desired program a list of programs already recorded or during recording, the data is transcoded into the format corresponding to the terminal device authenticated by the device authentication unit, and transmitted to the terminal device. Generally, video data is recorded at a high bit rate and the already recorded video data is transmitted by subjecting it again to encoding (re-encoding). Further, even for the program being recorded, the already recorded portion is re-encoded and transmitted so that even some one views the program being recorded by reproducing it, the program is re-encoded from the start thereof and transmitted for the terminal device. Therefore, the terminal device can view easily the data by receiving video signals transmitted by re-encoding (down-converting or the like) the data into the format corresponding to each of terminal devices such as mobile phones even the storing and reproducing units are during recording or reproducing, without any labor of viewing the program by storing it in the file format of the terminal device. A mobile phone at a user can view moving images while receiving the stream, eliminating the inconvenience of waiting until the moving image file transfer is completed. It is convenient in program viewing because reservation recording of a desired television program is possible, when a user happens to find a desired a program at the destination location or when a user cannot go home at a predetermined time.

The present invention allows to view a program at various terminals such as a mobile phone, a mobile terminal and a personal computer. Even a program already recorded or during recording can view from other terminals by using re-encoding, and a user can be prompted to view video contents efficiently. For example, even a device during reservation recording cannot view conventionally the program unless there is a connected television receiver. However, the present invention allows to view a program during recording in a train in the midst of going home or in a moving vehicle, if communication is possible by a communication means such as the Internet.

Even a user having no time to view a television even if a program is recorded can view the recorded program in the midst of going home, in a short empty time or in a waiting time, if only there is a communicable environment such as the Internet. The user can therefore utilize the time effectively. There is an advantage of contributing to saving the storage capacity since the video signals are not required to be stored beforehand in the memory for the terminal use as in the conventional case.

### BRIEF DESCRIPTION OF THE DRAWINGS

FIG. 1 is a block diagram showing the fundamental structure of a contents viewing environment of a data processing device of the present invention.

FIG. 2 is a flow chart illustrating a contents viewing procedure in the contents viewing environment shown in FIG. 1.

FIG. 3 is a flow chart illustrating the contents viewing procedure when a temporary stop occurs while a program is viewed from a remote site.

### DESCRIPTION OF THE EMBODIMENTS

With reference to the accompanying drawings, description will be made on an embodiment of a data processing device and a data utilizing system according to an embodiment of the present invention.

### First Embodiment

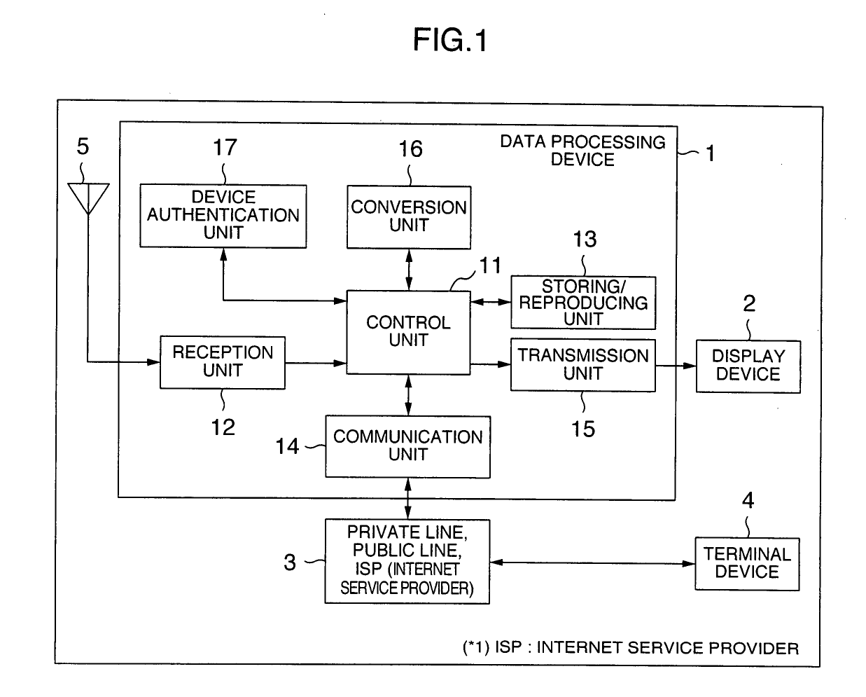

FIG. 1 is a block diagram showing the fundamental structure of a contents viewing environment of a data processing device of the present invention. In this embodiment, description will be made by using as an example of the data processing device of the invention a hard disk recorder (hereinafter called an HDD recorder) 1 which can record and reproduce audio/video contents data such as video signals and audio signals. The HDD recorder 1 has a control unit 11 which has a computer function equipped with a general CPU function.

The HDD recorder 1 mounts a reception unit 12 such as a tuner for receiving data such as video signals from an antenna 5 or the like for receiving broadcasting waves. Broadcasting waves include broadcasting waves recordable at respective bit rates of BS digital, 110° CS, ground wave digital, analog ground waves, BS analog broadcasting and the like. A storing/reproducing unit 13 of the HDD recorder 1 may be a video recording/reproducing device such as a hard disk, a server, a personal computer (PC) or the like. The storing/reproducing unit can record a program as video data of a high quality for a terminal device 4, in accordance with video signals received by the reception unit 12 and subjected to a recording process and the like.

The HDD recorder 1 has a communication unit 14 for connection to the terminal device 4 such as a mobile phone by using various communication means. In this example, the terminal device 4 is a mobile terminal such as a mobile phone, a PDA and a mobile personal computer. By using the mobile terminal as the terminal device 4, data stored in the HDD recorder 1 can be viewed on a display of the terminal device 4 even at a location outside a user's home. The communication unit 14 can communicate with the terminal device 4 by using a communication means such as a LAN, a wireless LAN, a private line, a public line and a UWB.

The HDD recorder 1 has a transmission unit 15 for transmitting video signals suitable for the type (analog, digital or the like) of a display device 2 to the display device 2 such as a television receiver and a personal computer monitor externally connected. The transmission unit 15 outputs and displays directly a received program or a program received, recorded and thereafter reproduced, on the display device 2.

For transmission, the HDD recorder 1 has a conversion unit 16. The conversion unit 16 transcodes signals such as video and data signals into a format suitable for the terminal device 4 (such as a packet communication format in conformity with an image processing format and a real time transmission format of wireless LAN or the like). In this example, since data of a program is received and recorded at a high bit rate, the data is down-converted into a packet data format, various compression formats or the like in accordance with device identification information of the terminal device 4 to be described later because the terminal device 4 is a mobile terminal, to thereby lower the bit rate and transmit the data such as video signals in the format suitable for the terminal device 4. However, the conversion unit 16 is not necessarily required to send data by lowering the bit rate, if the data can be encoded again in the format suitable for the terminal device 4 and can be transmitted. Namely, depending upon the type of the terminal device 4, the HDD recorder 1 may send a recorded program in the original image format itself or in a stream format.

The HDD recorder 1 has a device authentication unit 17 capable of registering beforehand a device ID to be used as an address specific to the terminal device 4, as registered device identification information. When the terminal device 4 connected via the communication unit 14 and communication means 3 such as a public line issues a transmission request for data such as video contents stored in the HDD recorder 1, device identification information of the terminal device 4 is also transmitted. In this manner, the device authentication unit 17 authenticates the device based on already registered device authentication information so that it is possible to automatically authenticate whether the terminal device 4 has already been registered. When it is authenticated that the terminal device 4 has already been registered, the format for transcoding the data sent from the HDD recorder 1 in a manner suitable for the terminal device 4 can be determined by confirming the registration contents such as an ID of the terminal device.

The device authentication unit 17 may have a user identifying function of identifying a user using the terminal device 4. For example, the user identifying function judges whether a password sent from the terminal device 4 is coincident with a password registered beforehand and known only by a true or authorized user. By providing the user identifying function, it is possible to judge whether the user of the terminal device is a true user. If a program is viewed by using a toll system, it is possible to protect a copyright, an individual privacy and the like.

The control unit 11 is connected to the reception unit 12, storing/reproducing unit 13, communication unit 14, transmission unit 15, conversion unit 16 and device authentication unit 17, and controls these units in accordance with the device identification information of the terminal device 4 connected via the control unit 14, and transcodes the data stored in the storing/reproducing unit 13 into the format suitable for the authenticated terminal device 4, and sends the transcoded data.

In response to a request from the terminal device 4, particularly the storing/reproducing unit 13 of the HDD recorder 1 is subjected to various controls. Namely, as the terminal device 4 is operated, and for example, if the terminal device is a mobile phone, a PDA, or a PC, as a key is operated, it is possible to control the operations of the storing/reproducing unit 13 including special reproduction, fast forward, fast backward, temporary stop, stop, recording, slow reproducing and the like. A user can access the HDD recorder 1 via the Internet to view a program already recorded in the HDD recorder or during recording. If a specific address, e.g., a domain name is assigned to the HDD recorder 1, a domain name service (DNS) provided by an Internet service provider (ISP) or the like can be used and the HDD recorder 1 can be provided with a communication function via the Internet. The mobile phone 4 can access the HDD recorder 1 via the Internet by using the domain name, to display a recorded program list and select a desired program to reproduce it.

Even if the HDD recorder 1 is during recording by a recording process or during reproducing already recorded contents, a user can send a request for a video signal transmission from the terminal device 4 to the HDD recorder 1, and the conversion unit 16 converts the program video signals into the format suitable for the type of the data terminal device 4 by a coding process such as transcoding (a series of data format change processes including encoding and decoding) and transmits the converted data so that the program can be viewed at the terminal device 4.

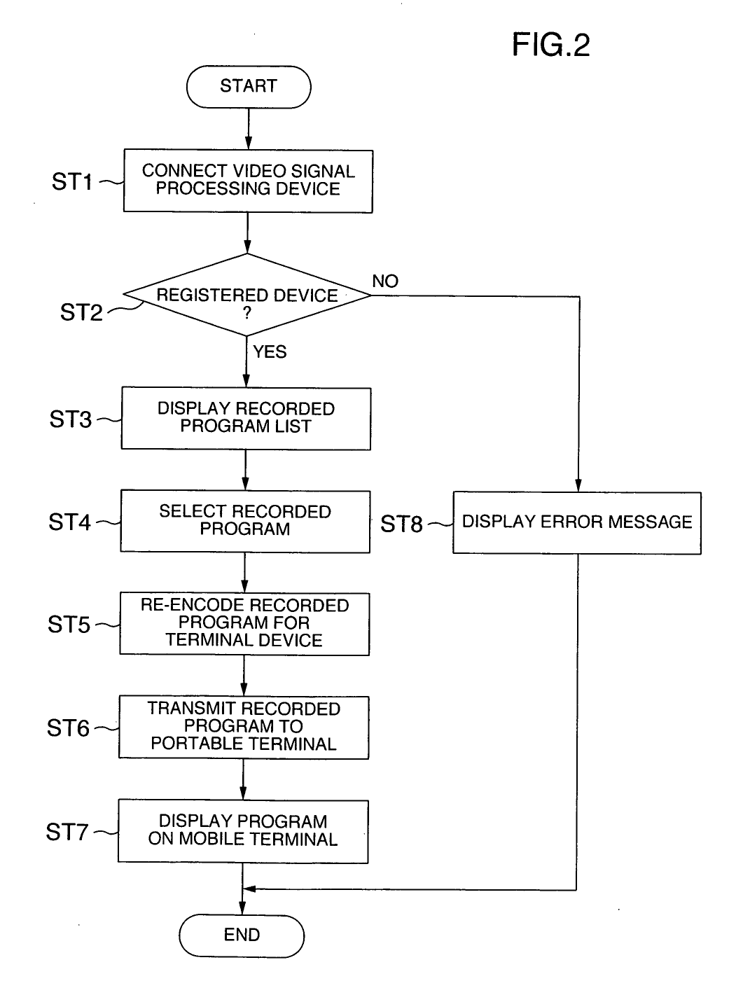

FIG. 2 illustrates a basic contents viewing flow between the data processing device and terminal device shown in FIG. 1. The terminal device 4 executes a process of connecting the HDD recorder 1 (ST1). Upon reception of a connection process signal, the HDD recorder 1 authenticates from the device ID whether the terminal device 4 is an already registered terminal device (ST2). Specifically, this device authentication is performed by the device authentication unit 17 of the HDD recorder 1 shown in FIG. 1. If the connected terminal device is not a registered terminal device, an error message is displayed on the terminal device to terminate the process (ST8). If the connected terminal device is the registered terminal device 4, a recorded program list is displayed on the terminal device 4 (ST3), and the terminal device 4 is controlled to allow a user to select a desired program from the recorded program list (ST4). Upon selection of a recorded program, the HDD recorder 1 encodes and reproduces the video signals of the recorded program recorded at a high bit rate (assuming a bit rate corresponding to so-called high vision broadcasting), and re-encodes the video signals into the video signal format suitable for the terminal device 4, in accordance with the device ID of the terminal device 4 (ST5). If the terminal device 4 has a small display screen such as a mobile terminal, the image quality and speed are lowered through down-conversion. The re-encoded video signals are transmitted to the terminal device 4 (ST6). The terminal device 4 decodes the received video signals and reproduces the program (ST7).

### Second Embodiment

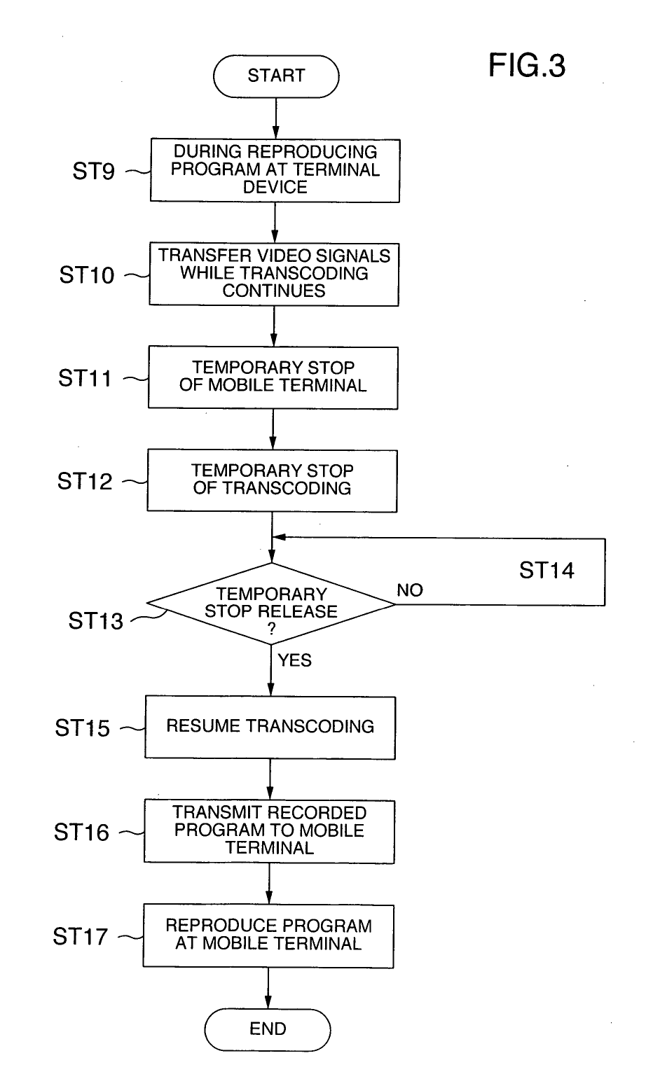

FIG. 3 is a flow chart illustrating the contents viewing procedure when a temporary stop occurs while a program is viewed from a remote site. While the terminal device 4 decodes video signals received from the HDD recorder 1 and reproduces a program (ST9), the HDD recorder 1 records master video signals and transcodes and transfers the master video signals (ST10). When a user temporarily stops the terminal device (ST11), the HDD recorder 1 waits for a temporary stop release (ST13) while the HDD recorder continues recording the master video signals (ST12), and transcoding for transfer is temporarily stopped (ST14). As the user resumes reviewing during the temporary stop, temporarily stopped transcoding resumes while the recording continues (ST15), video signals are transmitted to the terminal device 4 (ST16) and the program is reproduced at the mobile terminal 4 (ST17).

In the HDD recorder 1 as the data processing device, if data such as a program stored in the storing/reproducing unit 13 is the contents added with copy control information, a copy control function can be provided which inhibits other devices including the terminal device 4 to copy the data, in accordance with the copy control information. By using a publicization control function equipped to the HDD recorder 1, it becomes possible to set whether data is publicized or not publicized and to automatically judge data transmission in accordance with the settings of publicization and non-publicization.

If data to be used by the terminal device 4 is transcoded into a stream format as one type of formats so as to match the type of the terminal device, a function may be provided which directly records device identification information of the terminal device to the stream format data, in order for the terminal device to confirm transmission of the data from the data processing device. Namely, since there exists the function of directly recording the device identification information as the specific information of the terminal device as a connected device, to the stream, when the data processing device transcodes the data into a format suitable for the terminal device, the terminal device can confirm its specific information recorded in the stream when the data from the data processing device is viewed at the terminal device so that the terminal device can indirectly confirm the source location of the data. The device identification information as the specific information may be a telephone number if the terminal device is a mobile phone.

With these functions, various managements are possible. For example, access management by which an authorized user is authenticated, and only the authenticated user is provided with a key to decrypt encrypted digital contents, copy management by which illegal copy is suppressed by an electronic watermark or the like and illegal use is checked, ID management by which copyright information can be easily confirmed by assigning an ID for identifying each of respective contents, contributing to smooth distribution of contents, and toll management by which a contents use charge of a user is determined to establish reliable toll collection.

Although the embodiment has been described as the data processing device, the embodiment may also be applied to a data use system having an environment in which the terminal device is connected to the data processing device via a communication means, the terminal device issues a data transmission request to the data processing device, the data processing device transmits data in response to the transmission request from the terminal device, and the terminal device acquires the data transmitted from the data processing device to use data during recording or already recording data in the data processing device.

In the present invention, the configuration of concurrent encoding adopts the configuration of the HDD recorder and mobile phone. The present invention is not limited to the HDD recorder and mobile phone, but the present invention is applicable to all devices associated with various video recording devices to be used for program recording, video recording/reproducing devices such as servers, personal computers, mobile phones and mobile terminals. The invention is applicable not only to one HDD recorder and one mobile phone, but also to a plurality of personal computers and mobile terminals to be connected to the HDD recorder. Further, reproduction of a program at the terminal device includes not only simple reproduction of an already recorded program, but also succeeding reproduction of a program now being recorded and concurrent reproduction trying to reaching the present scene by increasing a reproduction speed.

Although the embodiment has been described above, the present invention is not limited thereto, but it is obvious that those skilled in the art can make various alterations and modifications without departing from the spirit of the present invention and the scope of appended claims.

1. A data processing device comprising:
storing and reproducing units built in or externally connected for storing and reproducing data;
a transmission unit for transmitting said data stored in said storing unit to a display device;
a communication unit for transferring various information to and from a terminal device;
a device authentication unit for authenticating said terminal device in accordance with device identification information of said terminal device sent from said terminal device connected via said communication unit;
a conversion unit for transcoding said data reproduced by said storing and reproducing units into a format corresponding to said terminal device authenticated by said device authentication unit; and
a control unit connected to each of said units for controlling each of said units to make said transmission unit transmit said data converted by said conversion unit to said terminal device.

2. The data processing device according to claim 1, wherein said device authentication unit authenticates said terminal device by comparing already registered device identification information specific to said terminal device with said device identification information of said terminal device sent from said terminal device.

3. The data processing device according to claim 2, wherein said device authentication unit has a user identification function or identifying a user using said terminal device.

4. The data processing device according to claim 1, wherein said format of a conversion destination to be converted by said conversion unit in accordance with said device identification information includes various formats including an original image data format, a stream data format, a packet data format, and a compression format.

5. The data processing device according to claim 1, wherein by an operation of said terminal device, said storing and reproducing units can perform operations including special reproduction, fast forward, fast backward, temporary stop, stop, recording, slow reproduction and the like.

6. The data processing device according to claim 1, wherein there are provided a copy control function of inhibiting other devices to copy said data stored in said storing and reproducing unit in accordance with copy control information of said data and a publicization control function of controlling publicization and non-publicization of said data.

7. The data processing device according to claim 1, wherein there is provided a function of, when said data to be used by said terminal device is transcoded into a stream format as one of said formats so as to match said terminal device, directly recording said device identification information of said terminal device to said data of said stream format in order for said terminal device to confirm transmission from the data processing device.

8. The data processing device according to claim 1, wherein said data is audio/video contents such as video signals and audio signals.

9. The data processing device according to claim 8, further comprising a reception unit for receiving said video signals, wherein said storing and reproducing units store said video signals received by said reception unit.

10. The data processing device according to claim 8, wherein said terminal device is a mobile terminal such as a mobile phone, a PDA and a mobile personal computer.

11. A data processing system having an environment wherein said terminal device is connected to the data processing device recited in claim 1 via a communication means, said terminal device issues a transmission request for said data to the data processing device, the data processing device transmits said data in response to said transmission request by said terminal device, and said terminal device acquires said data transmitted by said data processing device to use said data now being stored or said data already stored in the data processing device.
